(19) United States
(12) Patent Application Publication
(10) Pub. No.: US 2024/0308784 A1
(43) Pub. Date: Sep. 19, 2024

(54) TRANSFER DEVICE FOR TRANSFERRING COMPONENTS TO A SAFETY-CRITICAL PRODUCTION SIDE

(71) Applicant: INORES GMBH, Steinhausen (CH)

(72) Inventor: Felix WEDE, Erding (DE)

(21) Appl. No.: 18/264,977

(22) PCT Filed: Feb. 7, 2022
(86) PCT No.: PCT/EP2022/052879

§ 371 Date: Aug. 10, 2023

(30) Foreign Application Priority Data
Feb. 10, 2021 (EP) 21156404.2

(51) Int. Cl. B65G 47/90

(52) U.S. Cl. CPC B65G 47/907; B65G 47/905; B65G 2201/02; B65G 2203/041

(57) ABSTRACT

A transfer device for transferring components from a feed side to a production side on which a production robot is located, where the transfer device is configured to receive components and transfer them to the production side, where the transfer device compromises a pivotable component carrier which include(s) a component receptacle configured to receive a component, and the component carriers are each pivotable about mutually parallel axes and are pivotable from a loading position, in which components are able to be laid on the component receptacles from a side remote from the production side, into an unloading position, in which the components are removable from the production side.

### FIELD OF THE INVENTION

The invention relates to a transfer device for transferring components from a feed side to a safety-critical production side where a production robot is located, the transfer device being configured to pick up components and transfer them to the production side.

### BACKGROUND OF THE INVENTION

From the state of the art, in particular from automotive production, it is known to use production robots that can pick up ordered components and process then on a production table or similar devices. The production robots are located on a so-called production side, which must not be entered by workers for safety reasons. The underlying problem thus consists in feeding the components to the robot in an ordered manner without the need of workers entering the production side.

Usually, this is solved by physically separating a feed side from the production area, for example by a protective fence, and providing a so-called accumulating conveyor or a chute or a similar device, generally a transfer device, from the feed side through the protective fence to the production side. In such a structure, the production plant can be provided with a container holding components, a so-called components bin, on the feed side, which contains the components in a disordered manner. A production worker may then take components from the component bin and place them onto special pallets of the accumulating conveyor or onto shelves of other devices in an ordered position. The accumulation conveyor or a similar device can then move the ordered components through the protective fence to the production side, where they can be picked up and processed by the production robot.

To automate the process, known further developments provide that the production worker is replaced by an automated station, a so-called bin-picking station. Bin-picking stations are closed units meeting all safety regulations and machine guidelines. Such bin-picking stations thus precisely automate the act of picking components from the component bin and placing components onto the special pallets of the accumulating conveyor or onto shelves of other devices.

However, the systems now available that include manual placing or bin-picking stations, accumulating conveyors and production robots, still have disadvantages, since it is a costly system with high maintenance costs that requires a lot of space.

EP 3659744 A1 discloses a production device with an external loading side and an internal processing space. Initially, a workpiece is placed from the outside, i.e., from the loading side, onto a pivotable workpiece table. This can be done manually or via a robot. The production table is then pivoted so that the workpiece can be machined inside by a machine with a machining head. However, the workpiece cannot be removed immediately from the processing robot after processing, but the workpiece table must be pivoted back again, where it can be loaded with new workpieces.

DE 202004 009601 U1 describes a turntable on which at least two consoles are mounted. The workpieces are mounted by an operator on one side of a tool plate of the console. At the same time, a robot on the other side can process the workpiece and also remove it from the console. However, this is not a device that transfers a component from a safe side to a safety-critical production side.

### SUMMARY OF THE INVENTION

It is the object of the invention to create a transfer device for transferring components from a feed side to a safety-critical production side with a production robot, which can be formed more cost-effectively and requires less space.

This object is achieved by a transfer device for transferring components from a feed side to a safety-critical production side on which a production robot is located, wherein the transfer device is configured to receive at least one component or several components and to transfer them to the production side, wherein the transfer device comprises at least two component carriers that can be pivoted independently of one another, which comprise(s) at least two component receptacles for receiving a component, wherein the component carriers are each formed as elongated profiles, and wherein at least one component carrier is pivotable about an axis and moves from a loading position, in which components are able to be laid on the component receptacles from a side remote from the production side, into an unloading position, in which the components are removable from the production side.

It is preferred that the component carriers are pivotable about mutually parallel axes and are pivotable from a loading position, in which components are able to be laid on the component receptacles from a side remote from the production side, into an unloading position, in which the components are removable from the production side.

This so-called production buffer makes it possible to omit the use of accumulating conveyors or similar devices, which in particular eliminates the high investment costs and saves space. The production buffer can be implemented particularly easily thanks to the pivotable component carriers and does not require any conveyor belts or other devices, but instead transports the components simply by pivoting or rotating the component carriers from the feed side to the safety-critical production side. While the space required for a system comprising a bin-picking station, an accumulating conveyor and a production robot is approximately 15 m², the required space can be reduced to a total of approximately 2 m² with the device according to the invention.

In a particularly preferred embodiment, the transfer device comprises at least two component carriers that can be pivoted independently of one another. As a result, at least one of the component carriers can be constantly available for loading, while components can be removed from another component carrier by the production robot. Since the pivoting or rotating movement can also be carried out extremely quickly, there is no delay between the completion of a loading process and the time it is made available to the production robot. The advantages of the invention are even observable in the case of only a single component carrier, since the component carrier can, for example, be pivoted immediately from the unloading position to the loading position as soon as the production robot has removed a component from the component carrier, and in the loaded state it can be immediately pivoted from the loading position to the unloading position, for example before the production robot can pick up another component from the component carrier. Below, embodiment variants for a transport device with several component carriers and several component receptacles are explained, which, however, can also be used for transport devices with only one component carrier and/or only one component receptacle per component carrier.

In addition, it has been shown that the transfer device according to the invention, i.e., the production buffer, is advantageous not only in combination with a bin-picking station, but also in other applications, for example when the transfer device is loaded manually. Even in this case, the production buffer saves a considerable amount of space and reduces costs compared to accumulation conveyors or other transfer devices known from the state of the art.

The component carriers are particularly preferably pivotable about horizontal axes or about vertical axes. Furthermore, the axes can lie in a common vertical plane or in a common plane that is inclined relative to a vertical plane. If the plane of the production buffer is arranged vertically, the production buffer can, for example, form part of the side wall of the device, for example with a size of 0.2 m². The dimensions of such a production buffer can, for example, be 990 mm×1400 mm×200 mm. If the plane of the production buffer is inclined relative to the vertical plane, the components can be picked up particularly easily by the production robot, with the space requirement for such a production buffer being around 0.6 m². With these embodiments, a simple control for pivoting the component carrier can be achieved.

Furthermore, it is preferred that the axes of the component carriers each run through the mass centroid axes of the component carriers. This allows pneumatic or electromechanical pivoting or rotating with little effort despite the possibly strong cross-sections that are necessary and thus high weights of the component carriers.

The component carriers are particularly preferably elongated, preferably L-shaped, profiles on which the component receptacles are arranged linearly. As a result, the component carriers can be manufactured particularly easily, with a component carrier having a row or line of component receptacles.

In a further preferred embodiment, the component carriers have a first and a second carrier wall and the component receptacles are arranged in a spandrel between the first carrier wall and the second carrier wall, the first carrier wall preventing access from the production side to the component carrier in the loading position and the second carrier wall preventing access of the gripping robot to the component carrier in the unloading position. As a result, the component carriers may not only represent a receptacle for the components, but also form the protection or outer wall of the device or part of the protective fence, since the carrier walls form, in both operating positions, a partition between the interior of the device or the feed side and the production area.

In order for the production buffer to also form a continuous side wall of the device, it is preferred if the component carriers are positioned in a way that there is a gap of no more than 0.5 cm, preferably no more than 0.3 cm, between the component carriers, regardless of whether they are in the loading position or the unloading position.

Furthermore, it is particularly advantageous if the component carriers also offer impact protection in the event of incorrect operation of the production robot. This can be achieved, for example, when the component carriers are made of metal, preferably steel, and have a thickness of at least 0.5 mm. Alternatively, the component carrier could also be made of plastic or ceramic to achieve the mentioned effect.

In an advantageous embodiment, the component carriers have additional component receptacles, wherein components are able to be placed onto the additional component receptacles by the gripping robot in the unloading position of the component receptacles and components are removable from the additional component receptacles via the production side in the loading position of the component receptacles. As a result, the component receptacles on the component carrier are duplicated, so that a component located on the component receptacle can be removed by the production robot and the gripping robot can place the next component onto the additional component receptacle immediately behind or next to it. The component carrier thus has at least two component receptacles in the same longitudinal direction, as a result of which the component carrier can be loaded and unloaded at the same time at this location.

The transfer device can also include a controller which is configured to pivot empty component carriers from the unloading position into the loading position and to pivot full component carriers from the loading position into the unloading position. As a result, the method can be, on the one hand, automated and, on the other hand, optimized, since there is no pivoting of only partially loaded component carriers.

An evaluation unit can detect when a component carrier Is fully, partially or not loaded, which, as is known from the state of the art, could receive sensor signals from a plurality of sensors, each monitoring one of the component receptacles. However, due to the large number of sensors required, the plurality of control inputs required at the evaluation unit, and the complexity of the evaluation, this method can only be implemented at great expense.

In a particularly preferred embodiment of the invention, the solution according to the invention therefore comprises an evaluation unit, a camera connected to the evaluation unit and a light spot under each of the component receptacles of all component carriers, with a respective light spot being recognizable by the camera when the respective component receptacle is unoccupied and unrecognizable by the camera when a component is located on the respective component receptacle, the evaluation unit being configured to recognize a component receptacle as occupied or covered when a respective light spot is visible or not in the picture taken by the camera. This solution has the advantage that the evaluation unit must only have one control input for receiving the picture from the camera. The evaluation of the picture taken by the camera as to whether light spots are visible in the picture or not can be implemented comparatively easily.

In the last-mentioned embodiment, all light spots of a component carrier can preferably be illuminated by a single light source, preferably an LED strip, and each can be formed by openings in the area of the component receptacles, wherein each component carrier preferably comprises an additional opening through which the light source is visible, even if all component receptacles are occupied by components. This enables a simple functional check of the light source without having to remove a component from the component carrier.

In a further aspect, the invention creates a bin-picking station particularly saving space, i.e., a device comprising a transfer device according to one of the embodiments described above and a gripping robot, the gripping robot being configured to pick up a component from a container and to place the component picked up from the container on the transfer device.

In order to form the device in a closed manner, it can comprise a housing, wherein the gripping robot is enclosed by the housing and the component carrier forms a side wall of the device, wherein the container is insertable into the device via an insertion opening on the feed side. As a result, the device is formed in a particularly compact and safe manner and can be sold, in particular, as a modular unit that does not require a connection to an accumulating conveyor or the like.

Overall, a system can thus be created comprising a device and a production robot located on the production side, which is configured to pick up components from component carriers that are in the unloading position.

### BRIEF DESCRIPTION OF THE DRAWINGS

Advantageous and non-limiting embodiments of the invention are explained in more detail below with reference to the drawings.

FIG. 1 shows a system with a manual work station, an accumulating conveyor, and a production robot according to the state of the art.

FIG. 2 shows a device according to the invention in a first perspective view.

FIG. 3 shows the device of FIG. 2 in a second perspective view.

FIGS. 4a and 4b show a first embodiment of a production buffer of the device according to the invention from two different directions.

FIG. 5 shows a second embodiment of a production buffer of the device according to the invention.

FIG. 6 shows a third embodiment of a production buffer of the device according to the invention.

FIG. 7 shows a detail of the production buffer of the device according to the invention.

### DETAILED DESCRIPTION OF EMBODIMENTS

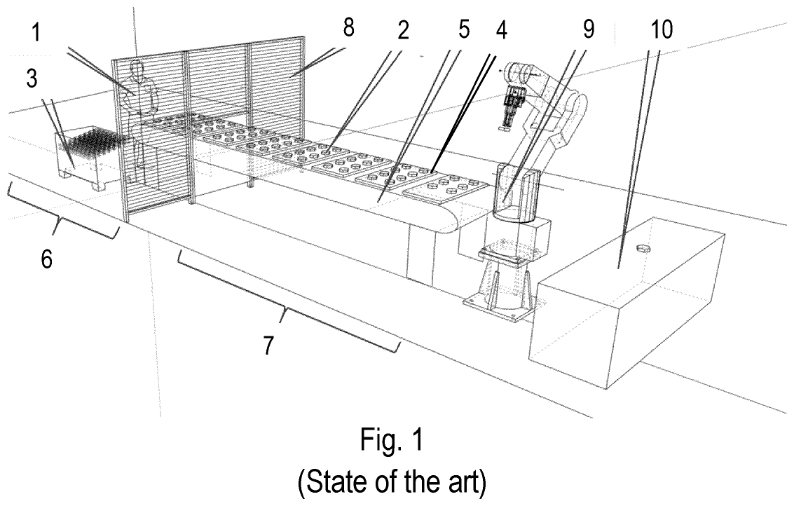

FIG. 1 shows a system known from the state of the art, in which a production worker 1 removes components 2 from a container 3 and places them in an ordered position on a special pallet 4 of an accumulating conveyor 5. The components 2 are disordered in the container 3 and must therefore be brought into the correct position manually by the production worker 1 before they are placed onto the pallet 4 of the accumulating conveyor 5.

The accumulating conveyor 5 moves the now ordered components 2 on the pallet 4 from the feed side 6, on which the production worker 1 is working, to the safety-critical production side 7, where staff are not allowed to enter. The feed side 6 is separated from the production side 7 by a protective fence 8. On the production side 7 there is a production robot 9 which picks up the components 2 ordered on the pallet 4 and processes them on a production table 10. This system is particularly common in the automotive industry.

It is known to replace the production worker 1 by a so-called bin-picking station reaching into the container 3 by means of a gripping robot to pick up a component 2, optionally subjecting it to a quality control, bringing it into the correct position and placing it onto the pallet 4 of the accumulating conveyor 5. The mechanics and control of the device described below, in particular the general techniques for picking up disordered components 2 from the container 3 and bringing the components 2 into a predetermined position, are known per se from the state of the art. However, the system described below has been further developed, particularly with regard to the transfer of the components 2 to the production area 7.

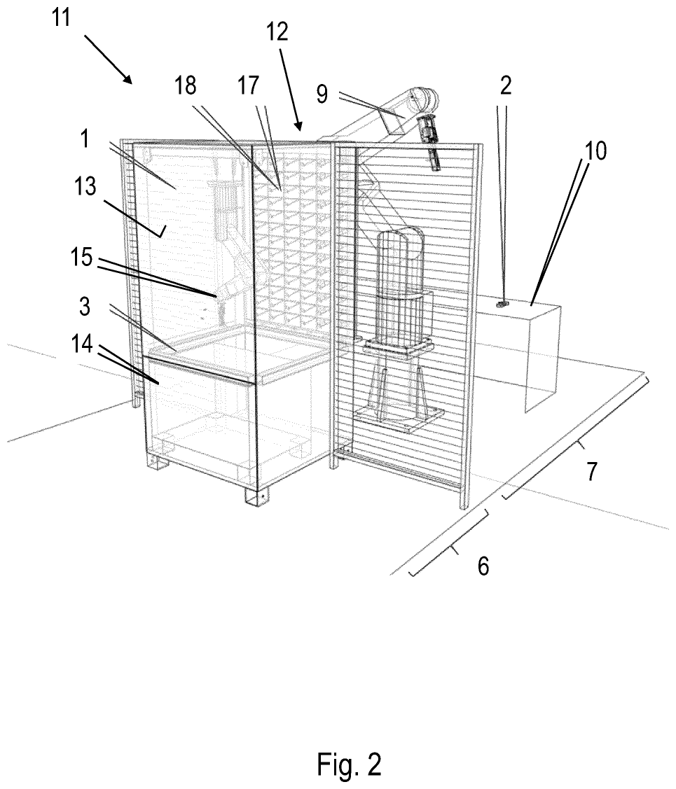

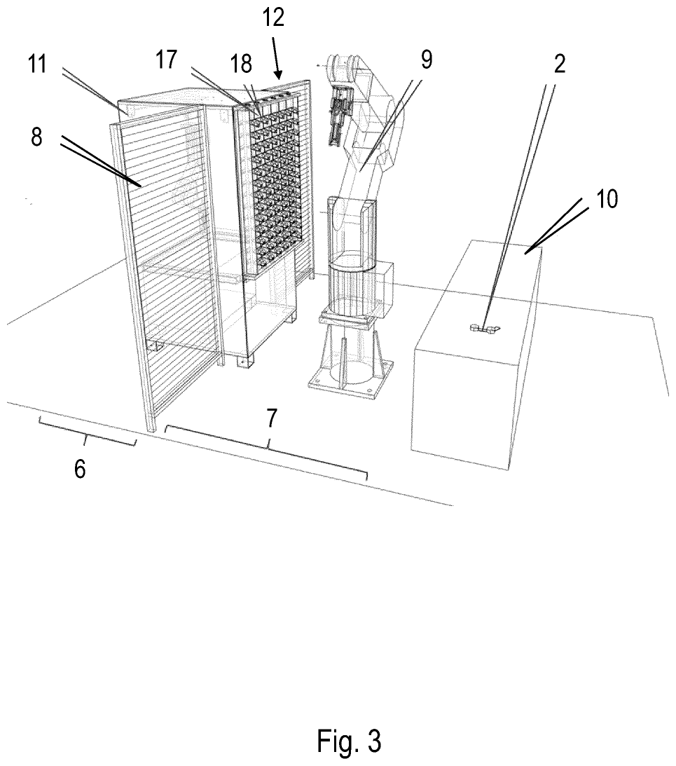

According to the invention, a device 11 is provided as shown in FIGS. 2 and 3, i.e., a bin-picking station, which has a transfer device 12 formed as a production buffer, as a result of which traditional accumulating conveyors 5 as shown in FIG. 1 can be omitted. Below, the device 11 is described in detail, wherein, in particular, the components 2, the container 3, the feed side 6, the production side 7, the protective fence 8, the production robot 9 and the production table 10 are unchanged compared to the embodiment of FIG. 1 and therefore provided with the same reference numbers.

The device 11 comprises a housing 13 with an opening 14 into which the container 3 with the components 2 can be manually or automatically inserted from the walk-in feed side 6. A gripping robot 15 with a gripping arm is provided inside the housing 13, which is configured to remove components 2 from the container 2 inserted into the device 11, optionally subject them to a quality control, for example by means of a camera and a picture evaluation unit, and move them to the transfer device 12 in an ordered position.

In analogy with the accumulating conveyor 5 of FIG. 1, the transfer device 12 formed as a production buffer is generally configured to pick up a large number of components 2 and transfer them to the production side 7. There, the production robot 9 can pick up the ordered components 2 and process them on the production table 10. In contrast to the embodiment of FIG. 1, however, the transfer device 12 is not configured as a conveyor belt, but comprises one or more pivotable component carriers 17, each having at least one component receptacle 18 or at least two component receptacles 18 for receiving a component 2. Herein, the term “pivoting” also includes the term “spinning”.

The component receptacles 18 can, for example, include one or more centering pins and/or position adaptors for the component 2 in order to ensure the correct positioning of the components 2 on the component carrier 17. The shape of the component receptacle 18 and the mutual distance between two component receptacles 18 on a component carrier 17 is generally dependent on the shape and the dimensions of the component 2 to be placed. There are usually two to thirty, preferably four to fifteen, component receptacles 18 on a component carrier 17. Also, the number of component carriers 17 can essentially be selected as desired, preferably between two and fifteen, particularly preferably between four and ten. Particularly preferably, the number of component receptacles 18 and the number of component carriers 17 can be selected in such a way that up to a hundred components 2 can be accessible on the production side 7 at the same time.

As explained below, the component carriers 17 can each be pivoted about an axis A without any translational movement and pivoted from a loading position, in which components 2 can be placed onto the component receptacles 18 by the gripping robot 15, to an unloading position, in which the components 2 can be removed on the production side 7. Due to the pivotability of the component carrier 17, there is no need for a linear transfer device. Usually, the gripping robot 15 cannot place any components 2 onto the component receptacles 18 when the component carrier 17 is in the unloading position, and the production robot 9 cannot remove any components 2 from the component receptacles 18 when the component carrier is in the loading position. The component receptacles 18 are configured in such a way that a component 2 located thereon does not shift with respect to the component carrier 17 during pivoting.

The component carriers 17 can be pivoted about the axes A independently of one another, for which a separate control unit can be provided. The component carriers 17 can preferably be pivoted pneumatically or electromechanically. The shaft thickness of a rotary bearing can be 20 mm, for example.

Usually, an empty component carrier 17 is pivoted into the loading position and then filled by the gripping robot 15. As soon as the component carrier 17 is full, it is pivoted into the unloading position, where the components 2 can be removed by the production robot 9. Since the component carriers 17 can be pivoted independently of one another, at least one component carrier 17 can be in the unloading position and one component carrier 17 in the loading position, which can generally ensure that components 2 can be made available to the production robot 9 at any time.

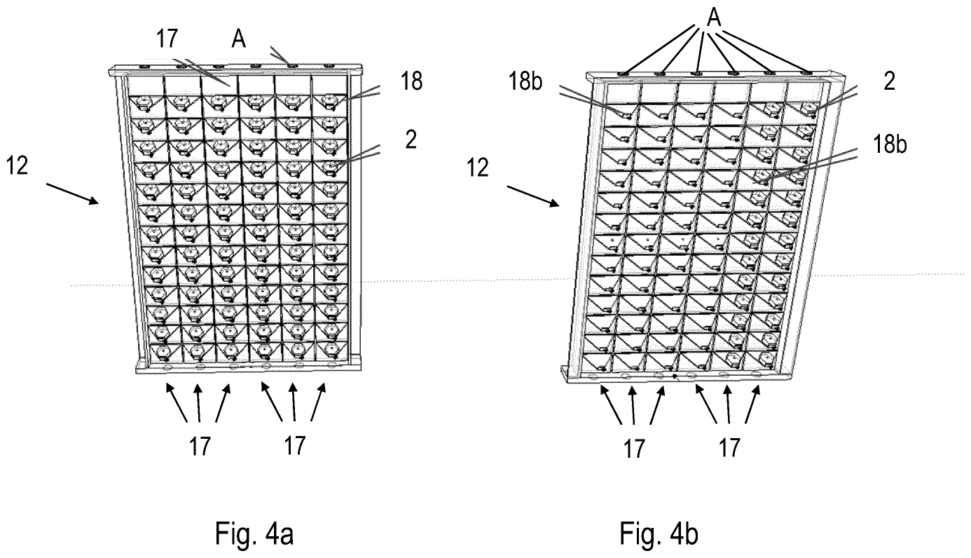

A first preferred embodiment of the transfer device 12 formed as a production buffer will now be explained with reference to FIGS. 4a and 4b. According to FIG. 4a, the transfer device 12 has six component carriers 17, each of which has thirteen component receptacles 18 and is pivotable about vertical axes A. These are arranged in a common vertical plane, so that the production buffer can be formed, for example, as a side wall of the device 11 or the housing 13, as is also shown in FIGS. 2 and 3.

FIG. 4a shows the production buffer of the production side 7. All component receptacles 18 have been filled and the component carriers 17 are all in the unloading position, i.e., the components 2 are accessible on the production side.

FIG. 4b shows the production buffer of FIG. 4a from the back, i.e., from inside the device 11. In this particular embodiment, the component carriers 17 have additional component receptacles 18b on the back, i.e., on the side remote from the component receptacles 18, which can be filled by the gripping robot 15 while components 2 can be picked up from the component receptacles 18 by the production robot 9.

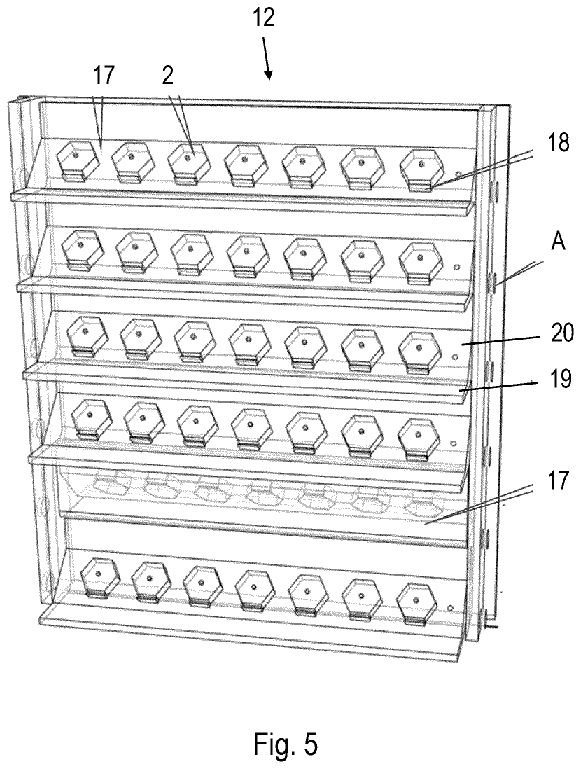

FIG. 5 shows an embodiment which is an alternative to the embodiments of FIGS. 4a and 4b. According to FIG. 5, six component carriers 17 are used, each of which can be pivoted about a horizontal axis A. The component carriers 17 each have seven component receptacles 18. The axes A are again in a common vertical plane, so that the production buffer could be used as a side wall of the device 11 or the housing 13. As shown, five of the six component carriers 17 are in an unloading position and one of the component carriers 17 is in the loading position.

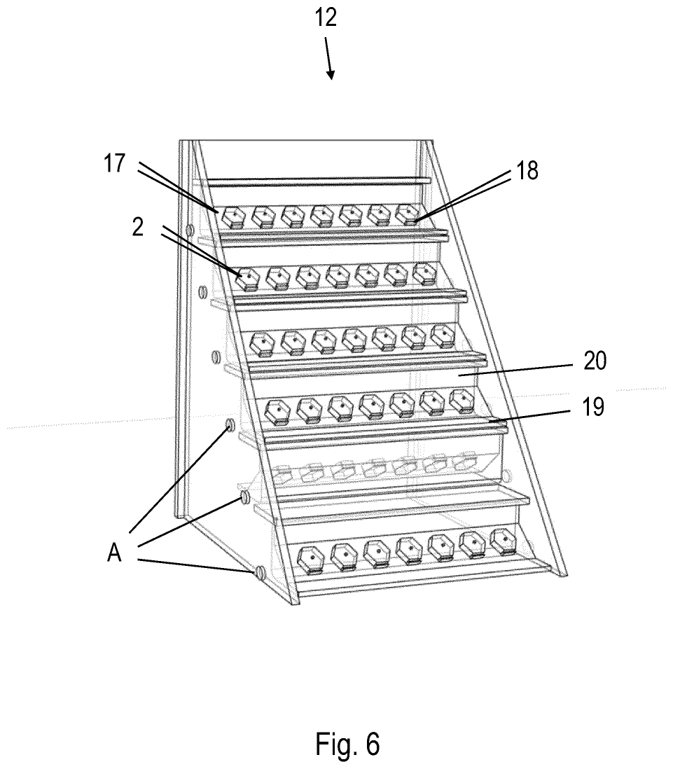

FIG. 6 shows a further embodiment in which the component carriers are each pivotable about a horizontal axis A. In contrast to the embodiment of FIG. 5, however, the axes A are not in a common vertical plane, but in a plane that is inclined relative to a vertical plane. This can, in particular, be provided to improve accessibility for the production robot 9.

It can be seen from FIGS. 5 and 6 that the component carriers 17 in this embodiment are elongated, L-shaped profiles on which the component receptacles 18 are arranged linearly, i.e., along a line and not in an array. As shown, the component carriers 17 can also have a first carrier wall 19 and a second carrier wall 20, with the component receptacles 18 being arranged in a spandrel between the carrier walls 19, 20. The first carrier wall 19 is to prevent access from the production side to the component carrier 17 in the loading position, and the second carrier wall 20 is to prevent access of the gripping robot 15 to the component carrier 18 in the unloading position. With reference to FIG. 6 it can be seen, for example, that the lowest component carrier 17 is in the unloading position and the second carrier wall 20 prevents the gripping robot 15 from accessing the component carrier 17. The second component carrier 17 from below; on the other hand, is in a loading position, so that the first carrier wall 19 prevents the production robot 9 from accessing the component carrier 17.

In the embodiment of FIGS. 5 and 6, the carrier walls are at an angle of 90° to one another. Here, the component carriers are each pivoted clockwise at an angle of 90° in order to bring the component carriers 17 from the loading position into the unloading position, and pivoted counterclockwise at an angle of 90° in order to move the component carriers 17 from the unloading position into the loading position. It can be provided, for example by mechanical locks, that the component carrier 17 can only be pivoted in a predetermined angular range and/or can only be moved in a first pivoting direction from the loading position to the unloading position and only in a second pivoting direction from the unloading position to the loading position, wherein the first pivoting direction is preferably opposite to the second pivoting direction.

Coming back to FIGS. 4a and 4b, it can be seen that the predetermined angular range for pivoting can also be 180°, for example, and the pivoting direction can be selected as desired. In this case, the component carrier 17 is not an L-shaped profile, but a board, i.e., a single carrier wall, which, in the simplest embodiment, is only provided with component receptacles 18 on one side. The side of the board with the component receptacles 18 can thus be pivoted from the unloading position to the loading position and vice versa by rotating it around 180°, with the pivoting direction being arbitrary. As described above with reference to FIG. 4b, the component carriers 17 can have additional component receptacles 18b, which are arranged, for example, on the back of the board. As a result, the components 2 can be placed onto the additional component receptacles 18b by the gripping robot 15 in the unloading position of the component carrier 17 and the components 2 can be removed from the additional component receptacles 18b on the production side 7 in the loading position of the component carrier 17. This principle can be extended if the component carrier 17 has, for example, three, four or more carrier walls, with component receptacles 18 being arranged in the spandrels of the carrier walls, so that at a rotation of the component carrier 17 by 360°, three, four or more components 2 can be provided in the same longitudinal position of the component carrier 17.

The component carriers 17 are preferably created in such a way that a penetration of an arm of the production robot 9 in case of a malfunction is prevented. For this purpose, the component carrier can be made of metal, preferably steel, and have a thickness of at least 0.5 mm. Alternative materials such as plastic or even ceramics could also be used for the component carriers, for example in order to make them particularly lightweight and therefore easily pivotable.

As a further safety measure, it can be provided that the component carriers 17 are positioned in such a way that there is a gap of max. 0.5 cm, preferably max. 0.3 cm, between the component carriers 17, regardless of whether they are in the loading position or the unloading position condition. Referring to FIGS. 4a-6, it can be seen that the gap is generally chosen to be so small that it is impossible to put ones hands through between the component carriers 17.

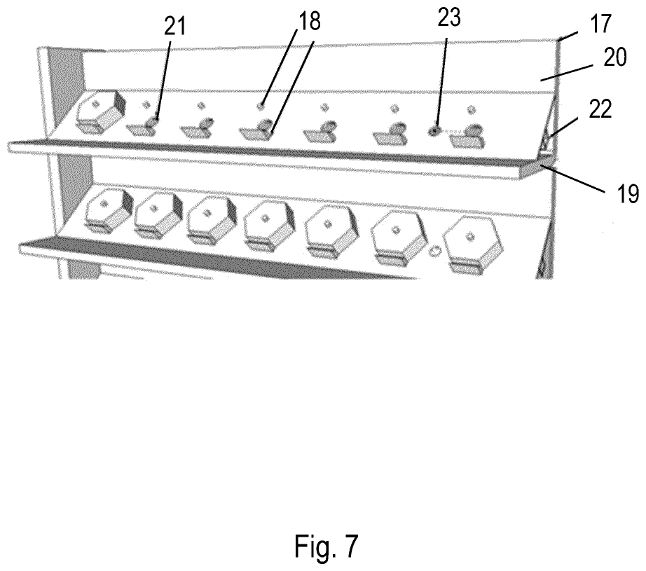

FIG. 7 shows a particularly advantageous option by means of which the device 11 can determine whether a component 2 is located on a component receptacle 18. As can be seen on the upper, largely unfilled component carrier 17, there is a light spot 21 under each of the component receptacles 18, which can be seen by a camera (not shown) when there is no component 2 on the respective component receptacle 18. However, if a component 2 is placed onto a component receptacle 18, the associated light spot 21 is covered. By recognizing a light spot 21, the mentioned camera or an evaluation unit connected to it can determine whether the associated component receptacle 18 is occupied or not.

In the embodiment of FIG. 7, all light spots 21 are illuminated by a common light source, here a LED strip 22, wherein an aperture, e.g., a bore, in the component carrier 17 is provided for each light spot, through which the LED strip 22 is visible. All light spots 21 of the component carrier 17 are thus illuminated by a single light source.

In the aforementioned embodiment, an additional opening 23 can be provided in the component carrier 17, through which the light source is visible, in order to generate a control light. The additional opening 23 is provided on the component carrier 17 in such a way that the control light is visible even if all component receptacles 18 are occupied by a component 2. This means that the functioning of the light source can be checked at any time. If the control light was not present, it would not be possible to distinguish whether all component receptacles 18 are occupied by a component 2 or whether the light source is not working.

As an alternative to the aforementioned embodiment, in which the presence of a component 2 on a component receptacle 18 is determined by detecting a visible or non-visible light spot 21 in the picture from a camera, the presence of a component 2 can also be detected using a programmable logic controller (PLC) with conventional sensors. The conventional sensors are, for example, light barriers, capacitive or inductive sensors. A purely mechanical detection of components 2 on the component receptacles 18 is also possible.

In all of the aforementioned embodiments, the device is configured to pick up only one type of component 2 from the container 3 and place it onto the component carrier 17. This means that all components 2 have the same dimensions and are manufactured in essentially the same way, so that all component receptacles 18 are also manufactured in the same way. In other embodiments, however, several containers 3 could be introduced into the device 11, in each of which different components 2 with different dimensions are supplied, so that, e.g., the first container 3 contains components 2 with first dimensions and the second container 3 contains components 2 with second dimensions. It can be seen that it may be necessary to adapt component receptacles 18 to the different components 2 if the component receptacles 18 are not configured as universal component receptacles for components 2 of different dimensions. For example, the device 11 can comprise at least one first component carrier 17 comprising first component receptacles 18, onto which components 2 with first dimensions can be placed, and at least one second component carrier 17 comprising second component receptacles 18, onto which components 2 with second dimensions can be placed. Alternatively or additionally, a component carrier 17 could be used, which includes both at least one first component receptacle 18, onto which components 2 with first dimensions can be placed, and at least one second component receptacle 18, onto which components 2 with second dimensions can be placed.

The gripping robot 15 can now be configured to pick up components 2 with first dimensions from the first container 3 and place them onto a first component receptacle 18, which is configured to receive corresponding components 2, and components 2 with second dimensions from the second container 3 and place them onto a second component receptacle 18, which is configured to receive corresponding components 2.

1-15. (canceled)

16. A transfer device for transferring components from a feed side to a production side where a production robot is located,
the transfer device being configured to pick up at least one component and transfer it to the production side, wherein the transfer device comprises at least two component carriers that can be pivoted independently of one another, each comprising at least one component receptacle configured to receive a component, wherein the component carriers are each formed as elongated profiles, and wherein the component carriers are each pivotable about an axis and movable from a loading position, in which components are able to be laid on the component receptacles from a side remote from the production side, into an unloading position, in which the components are removable from the production side.

17. The transfer device according to claim 16, wherein the component carrier(s) is/are pivotable about a horizontal axis.

18. The transfer device according to claim 16, wherein the component carrier(s) is/are pivotable about a vertical axis.

19. The transfer device according to claim 16, comprising at least two component carriers, wherein the axes lie in a common vertical plane or in a common plane that is inclined relative to a vertical plane.

20. The transfer device according to claim 16, wherein the axis of the component carrier runs through a mass centroid axis of the component carrier.

21. The transfer device according to claim 16, wherein the component carriers are elongated profiles on which at least two component receptacles are arranged linearly.

22. The transfer device according to claim 16, wherein the component carriers each have a first carrier wall and a second carrier wall and the at least one component receptacle is arranged in a spandrel between the first carrier wall and the second carrier wall, the first carrier wall preventing access from the production side to the component carrier in the loading position and the second carrier wall preventing access to the component carrier in the unloading position.

23. The transfer device according to claim 16, wherein the component carriers are positioned in such a way that there is a gap of no more than 0.5 cm between the component carriers, regardless of whether they are in the loading position or the unloading position.

24. The transfer device according to claim 16, wherein the component carrier is made of metal and has a thickness of at least 0.5 mm.

25. The transfer device according to claim 16, wherein the component carrier has at least one additional component receptacle, wherein components are able to be placed onto the at least one additional component receptacle in the unloading position of the component receptacle from the side remote from the production side, and the components are removable from the at least one additional component receptacle via the production side in the loading position of the component receptacle.

26. The transfer device according to claim 16, further comprising a controller that is configured to pivot an empty component carrier from the unloading position into the loading position and to pivot a full component carrier from the loading position into the unloading position.

27. The transfer device according to claim 16, further comprising an evaluation unit, a camera connected to the evaluation unit and a light spot under each of the component receptacles of all component carriers, with a respective light spot being recognizable by the camera when the respective component receptacle is unoccupied, and unrecognizable by the camera when a component is located on the respective component receptacle, and
the evaluation unit being configured to recognize a component receptacle as occupied or covered when a respective light spot is visible or not in the picture taken by the camera.

28. The transfer device according to claim 27, wherein all light spots of a component carrier are illuminated by a single light source, and each is formed by openings in the area of the component receptacles, wherein each component carrier comprises an additional opening through which the light source is visible, even if all component receptacles are occupied by components.

29. A device for picking up a component from a container and transferring the component to a production side, comprising a transfer device according to claim 16 and a gripping robot, wherein the gripping robot is configured to pick up a component from a container and to place the component picked up from the container onto the transfer device, wherein the device comprises a housing enclosing the gripping robot, wherein the component carrier forms a side wall of the device, and wherein the container can be inserted into the device via an insertion opening.

30. A system comprising the device according to claim 29 and a production robot located on the production side, which is configured to pick up components from component carriers that are in the unloading position.
